(19) United States
(12) Patent Application Publication
(10) Pub. No.: US 2023/0049497 A1
(43) Pub. Date: Feb. 16, 2023

(54) STRETCHABLE TEXTILE ARTICLE

(71) Applicant: Stretchline Intellectual Properties Limited, Long Eaton, Nottingham (GB)

(72) Inventors: L. A. D. Krishan Chaminda WEERAWANSA, Columbo (LK); A. Nalantha Priyaranga De Alwis, Panadura (LK)

(73) Assignee: Stretchline Intellectual Properties Limited, Long Eaton, Nottingham (GB)

(21) Appl. No.: 17/784,372

(22) PCT Filed: Dec. 11, 2020
(86) PCT No.: PCT/GB2020/053180

§ 371 Date: Jun. 10, 2022

(30) Foreign Application Priority Data
Dec. 12, 2019 (GB) 1918297.1

(51) Int. Cl. D03D 15/56; B32B 7/022; B32B 5/02; B32B 5/04; B32B 5/14; B32B 7/05; B32B 7/09; B32B 5/26; B32B 5/06; A41B 9/16

(52) U.S. Cl. CPC D03D 15/56; B32B 7/022; B32B 5/024; B32B 5/04; B32B 5/142; B32B 7/05; B32B 7/09; B32B 5/263; B32B 5/073; A41B 9/16; B32B 2437/00; B32B 2307/51; A41D 2300/22; D10B 2501/00; D10B 2401/061

(57) ABSTRACT

A stretchable textile article (20) comprises a plurality of discrete textile members (22,24), each textile member (22,24) extending between a first end (26) and a second end (28), the first ends (26) of the textile members (22,24) being joined together, the econd ends (28) of the textile members (22,24) being joined together, each textile member (22,24) including a textile zone configured to have a variable stretch property in an orientation extending between the joined first ends (26) and the joined second ends (28).

This invention relates to a stretchable textile article, preferably for use in a garment or a technical textile.

It is known to use stretchable textile articles to provide textile-based products, such as garments and technical textiles, with stretch properties.

According to an aspect of the invention, there is provided a stretchable textile article comprising a plurality of discrete textile members, each textile member extending between a first end and a second end, the first ends of the textile members being joined together, the second ends of the textile members being joined together, each textile member including a textile zone configured to have a variable stretch property in an orientation extending between the joined first ends and the joined second ends.

The term “textile” with reference to the invention is intended to cover, but is not limited to, the terms “cloth” and “fabric”. In addition, the invention is applicable, but is not limited to, woven and non-woven textiles.

The term “discrete” with reference to the discrete textile members of the stretchable textile article of the invention is intended to mean that the textile members are individually separate and distinct textile members.

There are several ways of joining the ends of the discrete textile members. Such ways may include, but are not limited to, stitching, using adhesive, using permanent or temporary fasteners, connecting the ends via additional textile sections, and so on.

The combination of the plurality of discrete textile members joined at the first and second ends and the inclusion of a textile zone having a variable stretch property in each textile member results in a multi-modulus stretchable textile article with stretch properties which is not available to, or readily producible in, a single textile member. In addition, by employing the use of discrete textile members, the stretch properties of the stretchable textile article of the invention can be easily customised to match the requirements of a wide range of textile products and applications. Such customisation may include choosing a suitable variable stretch property, shape and size of each discrete textile member.

The variable stretch property of each textile member may be the same as, or different from, the variable stretch property of the or each other textile member. The textile zone of each textile member may extend partially or entirely across a length of the corresponding textile member between the first and second ends.

The arrangement of the discrete textile members in the stretchable textile article of the invention may vary so long as the first ends of the textile members are joined together and the second ends of the textile members are joined together. Such variation in the arrangement of the discrete textile members in the stretchable textile article of the invention may depend on the requirements of the associated textile product and/or application, such as functionality and aesthetics. For example, the textile members may be arranged to:

extend parallelly, or substantially parallelly, between the joined first ends and the joined second ends; and/or

flank each other between the joined first ends and the joined second ends; and/or

overlie each other between the joined first ends and the joined second ends.

Different stretch properties of the stretchable textile article can be obtained through various configurations of each textile member to have a variable stretch property in an orientation extending between the joined first ends and the joined second ends.

In embodiments of the invention, the textile zone of each textile member may have a continuously or discontinuously variable stretch property in the orientation extending between the joined first ends and the joined second ends. That is to say, the plurality of textile members may be configured so that: each of the textile zones has a continuously variable stretch property in the orientation extending between the joined first ends and the joined second ends; or each of the textile zones has a discontinuously variable stretch property in the orientation extending between the joined first ends and the joined second ends; or one or more of the textile zones has a continuously variable stretch property in the orientation extending between the joined first ends and the joined second ends, while the or each other textile zone has a discontinuously variable stretch property in the orientation extending between the joined first ends and the joined second ends.

In other embodiments of the invention. the textile zone of at least one of the textile members may include a plurality of textile sub-zones arranged successively in the orientation extending between the joined first ends and the joined second ends, each textile sub-zone may have a respective constant or substantially constant stretch property, and the stretch properties of the textile sub-zones of the at least one textile member may be different from each other. In such embodiments, the textile zone of each textile member may include first and second textile sub-zones arranged successively in the orientation extending between the joined first ends and the joined second ends, and the first and second textile sub-zones of each textile member may be positioned towards the first and second ends respectively.

The plurality of textile members may include at least one first textile member and at least one second textile member. The stretch property of the textile zone of the or each first textile member may increase away from the first end towards the second end. The stretch property of the textile zone of the or each second textile member may increase away from the second end towards the first end.

By configuring the stretch properties of the textile zones of the first and second textile members to increase in opposite directions between the first and second ends, application of a load, force or stress to cause overall stretching of the stretchable textile article causes relative stretch between the first and second textile members in opposite directions as a result of the different stretch properties of the first and second textile members.

The stretch properties of the first and second textile sub-zones of the or each first textile member may be selected so that the first and second textile sub-zones of the or each first textile member respectively exhibit non-stretchability and stretchability. The stretch properties of the first and second textile sub-zones of the or each second textile member may be selected so that the first and second textile sub-zones of the or each second textile member respectively exhibit stretchability and non-stretchability.

A material exhibiting stretchability is a material that is capable of extending when subjected to an applied load, force or stress and then reverting to its original shape and size upon release of the applied load, force or stress. A stretchable material tends to have a high stretch property. A material exhibiting non-stretchability is a material that is incapable of extending when subjected to an applied load, force or stress and then reverting to its original shape and size upon release of the applied load, force or stress. A non-stretchable material tends to have a low stretch property.

By configuring the stretch property of the first and second textile sub-zones of the first and second textile members in the foregoing manner, application of a load, force or stress to cause overall stretching of the stretchable textile article causes a reduction in distance, or an increase in overlap, between the stretchable textile sub-zones as a result of the non-deformation, or minimal deformation, of the non-stretchable textile sub-zones.

The textile sub-zones of the first and second textile members may be arranged so that, when the stretchable textile article is in an unstretched state:

the first textile sub-zone of the or each first textile member overlaps with the second textile sub-zone of the or each second textile member; or

the first textile sub-zone of the or each second textile member overlaps with the second textile sub-zone of the or each first textile member; or

the first textile sub-zone of the or each first textile member does not overlap with the second textile sub-zone of the or each second textile member, and the first textile sub-zone of the or each second textile member does not overlap with the second textile sub-zone of the or each first textile member.

When the stretchable textile article is in an unstretched state, it means that there is no net load, force or stress applied to the stretchable textile article which results in the stretchable textile article extending beyond its original shape and size. When the stretchable textile article is in a stretched state, it means that the stretchable textile article extends beyond its original shape and size in one or more dimensional orientations as a result of the application of a net load, force or stress in the or each such dimensional orientation.

In embodiments of the invention, the plurality of textile members may include a plurality of first textile members and/or a plurality of second textile members. The number of first textile members and the number of second textile members depend on the requirements of the associated textile product and/or application. Also, in such embodiments, the first and second textile members may be arranged in different ways to vary the overall stretch properties of the stretchable textile article. For example, the first and second textile members may be arranged to form alternately positioned first and second textile members.

In further embodiments of the invention, the stretchable textile article may further include at least one fastener arranged to releasably fasten the textile members to each other at a fastening point or region between the first and second ends. In such embodiments, the or each fastener may be configurable to releasably fasten the textile members to each other when the stretchable textile article is in an unstretched state and/or in at least one stretched state.

Releasably fastening the textile members to each other using the or each fastener enables modification of the overall stretch properties of the stretchable textile article. In addition, such modification of the overall stretch properties of the stretchable textile article remains fixed, i.e. unchanged, until the or each fastener is released. Accordingly, the provision of the or each fastener enables the reconfiguration of the stretchable textile article to modify its overall stretch properties.

The or each fastener may be in the form of, for example, a button fastener, a snap fastener, a hook and eye closure, a hook and loop fastener, a clip, a clamp, a wire tie, a zip tie, a cable tie, and any other fastener that can be configured to releasably fasten the textile members to each other when the stretchable textile article is in an unstretched state and/or in at least one stretched state.

The shape of each textile member may vary depending on the requirements of the stretchable textile article, such as functionality and aesthetics. For example, each textile member may be in the shape of a strip.

The stretchable textile article may be configured as a structural support component. Alternatively, the stretchable textile article may be configured for forming part of a structural support component. For example, the structural support component may be a strap or a band, which may be for a garment, an undergarment, a bag, a seat belt, and footwear.

The stretchable textile article may be used in a wide range of textile products, preferably garments and technical textiles. A garment is a textile product worn on a wearer's body. A technical textile is a textile product manufactured primarily for functional purposes, and may or may not have aesthetic purposes. Examples of technical textiles include, but are not limited to, industrial textiles, medical textiles, protective textiles, electronics textiles, and so on.

It will be appreciated that the use of the terms “first” and “second”, and the like, in this patent specification is merely intended to help distinguish between similar features (e.g. the first and second textile members, the first and second textile sub-zones, etc.), and is not intended to indicate the relative importance of one feature over another feature, unless otherwise specified.

Preferred embodiments of the invention will now be described, by way of non-limiting examples, with reference to the accompanying drawings in which:

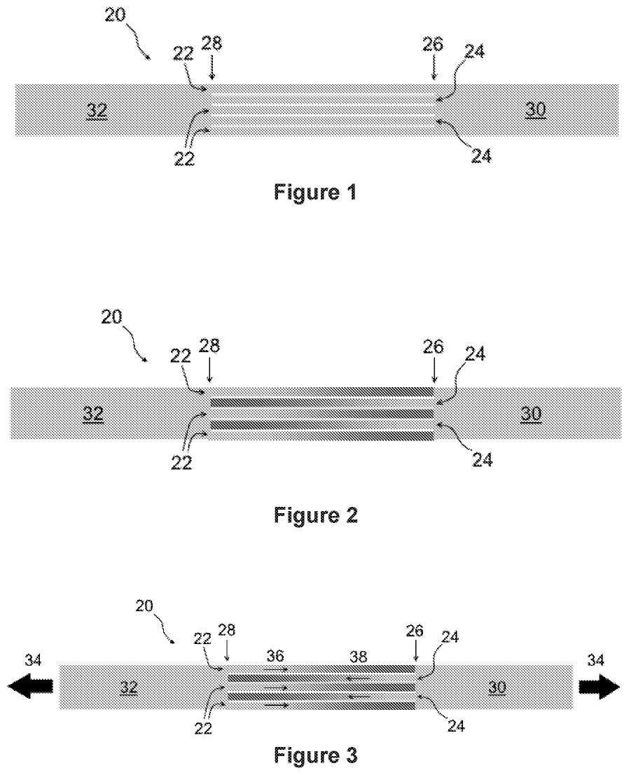

FIG. 1 shows a stretchable textile article according to a first embodiment of the invention;

FIG. 2 shows a variation of the stretch property along a length of each textile member of the stretchable textile article of FIG. 1;

FIG. 3 shows relative stretch between textile members of the stretchable textile article of FIG. 1 when a tensile load is applied to the stretchable textile article;

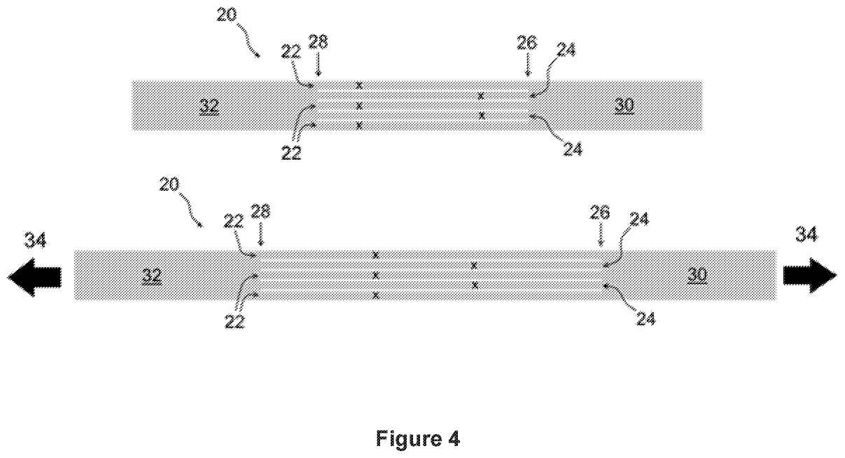

FIG. 4 shows a side-by-side comparison of the unstretched and stretched states of the stretchable textile article of FIG. 1;

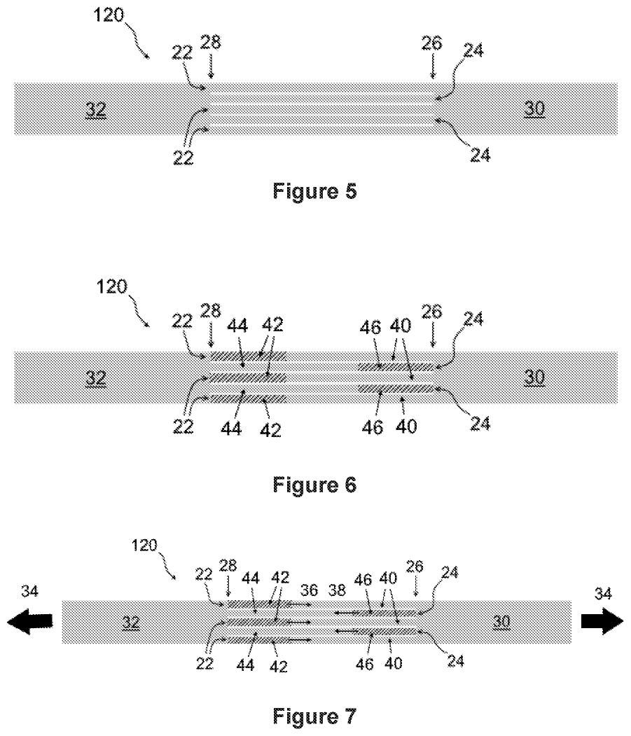

FIG. 5 shows a stretchable textile article according to a second embodiment of the invention;

FIG. 6 shows a variation of the stretch property along a length of each textile member of the stretchable textile article of FIG. 5;

FIG. 7 shows relative stretch between textile members of the stretchable textile article of FIG. 5 when a tensile load is applied to the stretchable textile article;

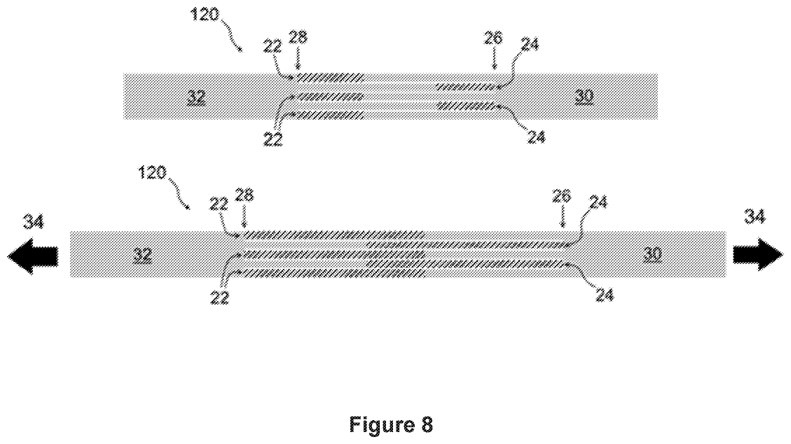

FIG. 8 shows a side-by-side comparison of the unstretched and stretched states of the stretchable textile article of FIG. 5;

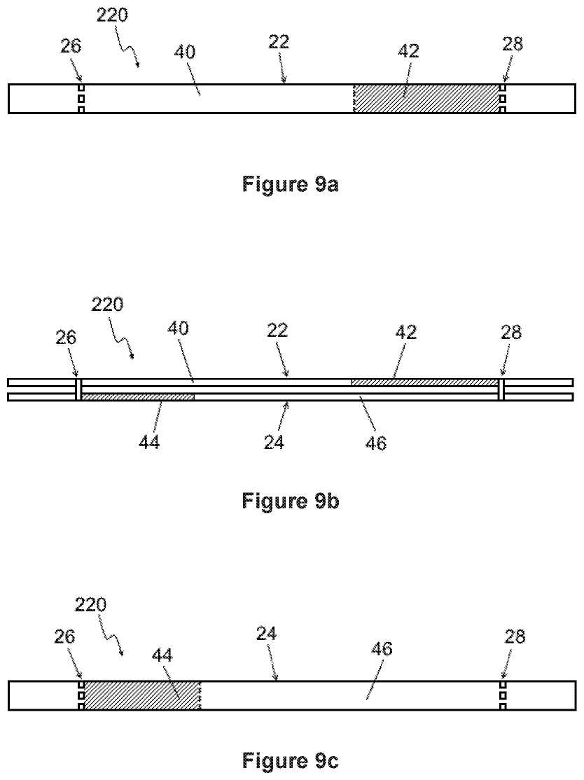

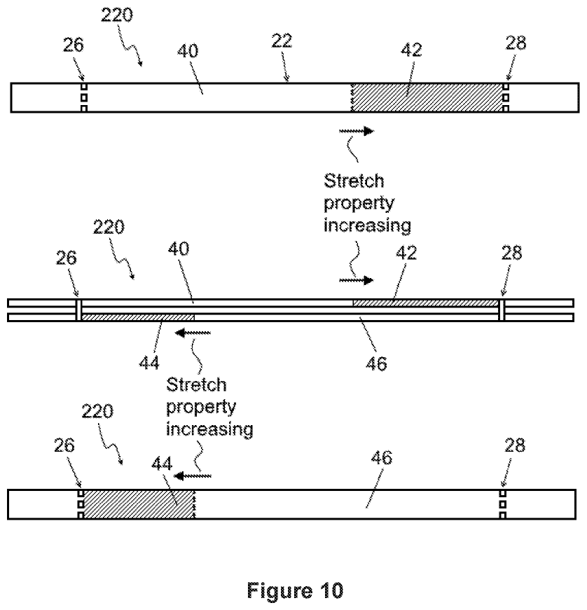

FIGS. 9a, 9b and 9c show a stretchable textile article according to a third embodiment of the invention; FIG. 10 shows a variation of the stretch property along a length of each textile member of the stretchable textile article of FIGS. 9a, 9b and 9c;

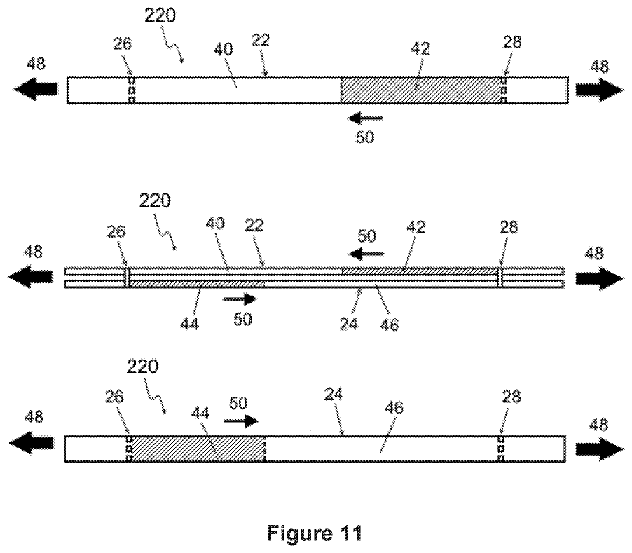

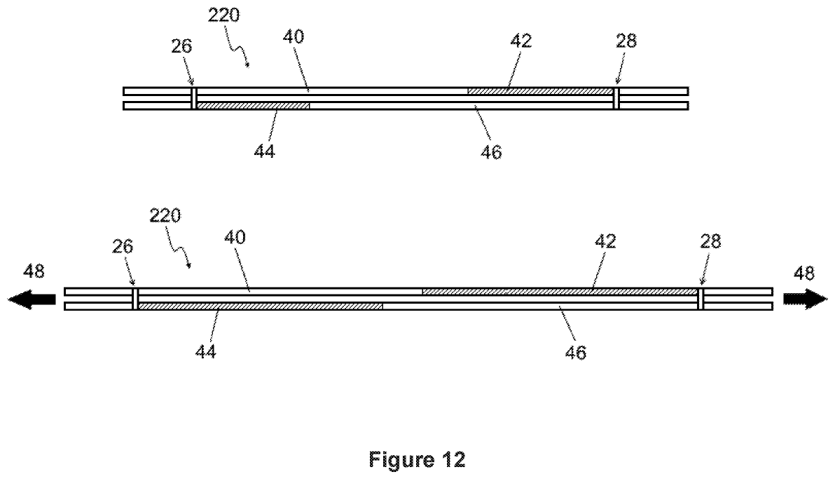

FIG. 11 shows relative stretch between textile members of the stretchable textile article of FIGS. 9a, 9b and 9c when a tensile load is applied to the stretchable textile article; FIG. 12 shows a side-by-side comparison of the unstretched and stretched states of the stretchable textile article of FIGS. 9a, 9b and 9c; and

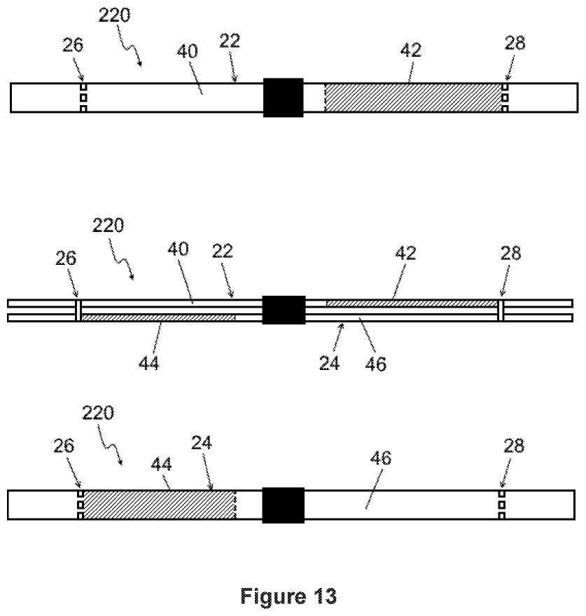

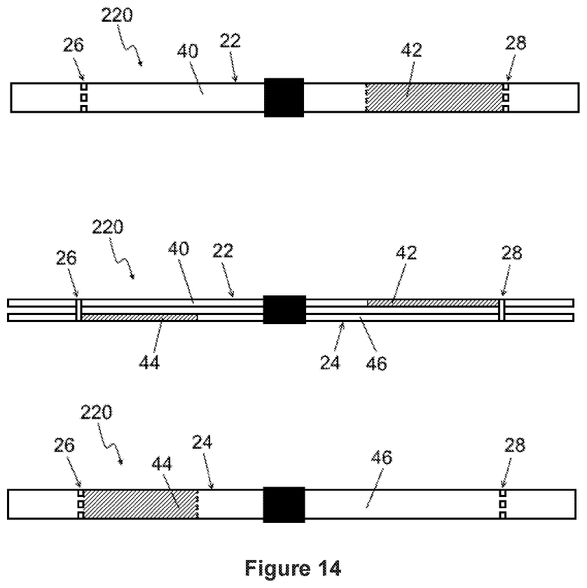

FIGS. 13 and 14 show the use of a fastener to releasbly fasten textile members of the stretchable textile article of FIGS. 9a, 9b and 9c.

The figures are not necessarily to scale, and certain features and certain views of the figures may be shown exaggerated in scale or in schematic form in the interests of clarity and conciseness,

The following embodiments of the invention are described with reference to stretchable textile articles made of woven textiles, but it will be appreciated that the working principle of each of the following embodiments of the invention is applicable mutatis mutandis to stretchable textile articles made of non-woven textiles,

A stretchable textile article according to a first embodiment of the invention is shown in FIG. 1 and is designated generally by the reference numeral 20.

The stretchable textile article 20 comprises a plurality of discrete textile members 22,24. Each textile member 22,24 is in the form of a textile strip extending between a first end 26 and a second end 28. The first ends 26 of the plurality of textile members 22,24 are joined together via a first textile section 30, and the second ends 28 of the plurality of textile members 22,24 are joined together via a second textile section 32. The plurality of textile members 22,24 extends parallelly, or substantially parallelly, between the joined first ends 26 and the joined second ends 28, such that the plurality of textile members 22,24 flank each other between the joined first ends 26 and the joined second ends 28. Each textile member 22,24 is spaced apart from each neighbouring textile member 22,24 between the joined first ends 26 and the joined second ends 28.

Preferably the first and second textile sections 30,32 are non-stretchable, or rigid, textile sections. That is to say, the stretch properties of the first and second textile sections 30,32 are selected so that the first and second textile sections 30,32 exhibit non-stretchability.

The plurality of textile members 22,24 includes a plurality of first textile members 22 and a plurality of second textile members 24. The first and second textile members 22,24 are arranged to form alternately positioned first and second textile members 22,24 between the joined first ends 26 and the joined second ends 28.

Each textile member 22,24 is made from an elastic woven textile material, and includes a textile zone extending fully along the length of the textile member 22,24. Each textile zone is configured to have a variable stretch property in an orientation extending between the joined first ends 26 and the joined second ends 28. More specifically, the textile zone of each first textile member 22 has a continuously increasing stretch property along the length of the textile strip away from the first end 26 towards the second end 28, and the textile zone of each second textile member 24 has a continuously increasing stretch property the length of the textile strip away from the second end 28 towards the first end 26. FIG. 2 shows the variation of the stretch property along the length of each textile member 22,24.

The variable stretch property of the textile zone of each textile member 22,24 may be obtained by varying the textile characteristics of each textile member 22,24. This may include, for example, varying the weave construction (a tighter weave results in a lower stretch property, and a looser weave results in a higher stretch property), or changing the yarn density.

The stretchable textile article 20 can be stretched by applying a tensile load 34 to the joined first ends 26 and the joined second ends 28. Since the respective stretch properties of the textile zones of the first and second textile members 22,24 increase continuously in opposite directions between the first and second ends 26,28, the application of the tensile load 34 results in relative stretch between the first and second textile members in opposite directions. This causes a portion of each first textile member 22 positioned towards the second end 28 to stretch 36 towards a portion of each second textile member 24 positioned towards the first end 26, and causes the portion of each second textile member 24 positioned towards the first end 26 to stretch 38 towards the portion of each first textile member 22 positioned towards the second end 28, as shown in FIG. 3. As a result, the distance between the two portions is reduced. In the event of the application of a sufficiently large tensile load 34, an overlap between the two portions can be obtained.

FIG. 4 shows a side-by-side comparison of the unstretched and stretched states of the stretchable textile article 20. ‘X’ markers are used to illustrate the stretch behaviour of the first and second textile members 22,24, and therefore the relative stretch between the first and second textile members 22,24.

The combination of the plurality of discrete textile members 22,24 joined at the first and second ends 26,28 and the inclusion of a textile zone having a variable stretch property in each textile member 22,24 therefore provides a multi-modulus stretchable textile article 20. The variable stretch property, shape and size of each discrete textile member 22,24 can be varied to customise the stretch properties of the stretchable textile article 20 to match the requirements of a wide range of textile products and applications.

As a result of the structure of the stretchable textile article 20, it is more effective to stretch the stretchable textile article 20 by gradually applying the tensile load as opposed to suddenly applying the tensile load, e.g. by using a snapping pulling motion.

Optionally, after stretching the stretchable textile article 20, a fastener may be used to releasably fasten the first and second textile members 22,24 together at a fastening point or region between the first and second ends 26,28. Such a fastener may be in the form of a clip that extends across the first and second textile members 22,24. The clip may be replaced by a different type of fastener. Examples of other fasteners are described elsewhere in this specification.

Further optionally the clip may be used to fasten the first and second textile members 22,24 together when the stretchable textile article 20 is in an unstretched state. Alternatively or additionally, the clip may be used to fasten the first and second textile members 22,24 together when the stretchable textile article 20 is in a stretched state. It will be appreciated that the stretchable textile article 20 can have multiple stretched states by varying the applied tensile load 34, and hence the clip may be used to fasten the first and second textile members 22,24 together in more than one stretched state of the stretchable textile article 20.

By clipping the first and second textile members 22,24 to each other, the overall stretch properties of the stretchable textile article 20 can be temporarily fixed until the clip is released. In this manner, the overall stretch properties of the stretchable textile article 20 may be modified through use of the fastener.

It is envisaged that, in other embodiments of the invention, the first and second textile members may be arranged between the first and second ends in other ways instead of alternately positioning the first and second textile members 22,24 between the first and second ends 26,28. For example, the textile members may be arranged so that the first textile members are grouped together at one side of the stretchable textile article, and the second textile members are grouped together at the other side of the stretchable textile article.

It is also envisaged that. in still other embodiments of the invention, the stretchable textile article 20 of FIG. 1 may include a single first textile member instead of a plurality of first textile members 22, and/or a single second textile member instead of a plurality of second textile members 24.

It is further envisaged that, in further other embodiments of the invention, the stretchable textile article 20 of FIG. 1 may include a plurality of fasteners, the or each fastener being configurable to releasably fasten the first and second textile members 22,24 together at a respective fastening point or region between the first and second ends 26,28.

A stretchable textile article according to a second embodiment of the invention is shown in FIG. 5 and is designated generally by the reference numeral 120. The stretchable textile article 120 of FIG. 5 is similar in construction to the stretchable textile article 20 of FIG. 1, and like features share the same reference numerals.

The stretchable textile article 120 of FIG. 5 differs from the stretchable textile article 20 of FIG. 1 in that, in the stretchable textile article 120 of FIG. 5, the textile zone of the first textile member 22 has a discontinuously increasing stretch property along the length of the textile strip away from the first end 26 towards the second end 28, and the textile zone of the second textile member 24 has a discontinuously increasing stretch property along the length of the textile strip away from the second end 28 towards the first end 26.

More specifically, as shown in FIG. 6, the textile zone of each textile member 22,24 includes first and second textile sub-zones 40,42,44,46 arranged successively along the length of the textile member 22,24 between the first and second ends 26,28. The first and second textile sub-zones 40,42,44,46 of each textile member 22,24 are positioned towards the first and second ends 26,28 respectively.

The textile sub-zone 40 of each first textile member 22 adjacent the first end 26 has a respective constant or substantially constant stretch property, and the textile sub-zone 42 of each first textile member 22 adjacent the second end 28 has a continuously increasing stretch property along the length of the textile sub-zone 42 away from the first end 26 towards the second end 28. The textile sub-zone 44 of each second textile member 24 adjacent the first end 28 has a respective constant or substantially constant stretch property, and the textile sub-zone 46 of each second textile member 24 adjacent the second end 28 has a continuously increasing stretch property along the length of the textile sub-zone 46 away from the second end 28 towards the first end 26.

The stretch properties of the first and second textile sub-zones 40,42 of each first textile member 22 are selected so that the first and second textile sub-zones 40,42 of each first textile member 22 respectively exhibit non-stretchability and stretchability. The stretch properties of the first and second textile sub-zones 44,46 of each second textile member 24 are selected so that the first and second textile sub-zones 44,46 of each second textile member 24 respectively exhibit stretchability and non-stretchability.

In the embodiment shown, the textile sub-zones 40,42,44,46 of the first and second textile members 22,24 are arranged so that, when the stretchable textile article 120 is in an unstretched state, the non-stretchable first textile sub-zone 40 of each first textile member 22 overlaps with the non-stretchable second textile sub-zone 46 of each second textile member 24.

In a similar fashion to the embodiment of FIG. 1, applying a tensile load 34 to the joined first ends 26 and the joined second ends 28 results in relative stretch 36,38 between the first and second textile members 22,24 in opposite directions, as shown in FIG. 7. This results in a reduction in overlap between the non-stretchable textile sub-zones 40,46 and therefore a reduction in distance between the stretchable textile sub-zones 42,44 as a result of the non-deformation, or minimal deformation, of the non-stretchable textile sub-zones 40,46, as shown in FIG. 7. In the event of the application of a sufficiently large tensile load 34, an overlap between the stretchable textile sub-zones 42,44 can be obtained.

FIG. 8 shows a side-by-side comparison of the unstretched and stretched states of the stretchable textile article 120.

A stretchable textile article according to a third embodiment of the invention is shown in FIGS. 9a, 9b and 9c and is designated generally by the reference numeral 220. The stretchable textile article 220 of FIGS. 9a, 9b and 9c is similar in construction to the stretchable textile article 20 of FIG. 1, and like features share the same reference numerals.

The stretchable textile article 220 of FIGS. 9a, 9b and 9c differs from the stretchable textile article 20 of FIG. 1 in that, in the stretchable textile article 220 of FIGS. 9a, 9b and 9c:

the plurality of textile members 22,24 includes a single first textile member 22 and a single second textile member 24;

the textile members 22,24 are arranged to extend parallelly, or substantially parallelly, between the joined first ends 26 and the joined second ends 28, and overlie each other between the joined first ends 26 and the joined second ends 28; and

the first ends 26 of the first and second textile members 22,24 are stitched together, and the second ends 28 of the first and second textile members 22,24 are stitched together.

FIG. 9a is a top view of the stretchable textile article 220, which shows the first textile member 22. FIG. 9b is a side view of the stretchable textile article 220, which shows both the first and second textile members 22,24. FIG. 9c is a bottom view of the stretchable textile article 220, which shows the second textile member 24.

The textile zone of the first textile member 22 has a discontinuously increasing stretch property along the length of the textile strip away from the first end 26 towards the second end 28, and the textile zone of the second textile member 24 has a discontinuously increasing stretch property along the length of the textile strip away from the second end 28 towards the first end 26.

More specifically, as shown in FIG. 10, the textile zone of each textile member 22,24 includes first and second textile sub-zones 40,42,44,46 arranged successively along the length of the textile member 22,24 between the first and second ends 26,28. The first and second textile sub-zones 40,42,44,46 of each textile member 22,24 are positioned towards the first and second ends 26,28 respectively. Each textile sub-zone 40,42.44,46 has a respective constant or substantially constant stretch property. The stretch properties of the first and second textile sub-zones 40,42 of the first textile member 22 are selected so that the first and second textile sub-zones 40,42 of the first textile member 22 respectively exhibit non-stretchability and stretchability. The stretch properties of the first and second textile sub-zones 44,46 of the second textile member 24 are selected so that the first and second textile sub-zones 44,46 of the second textile member 24 respectively exhibit stretchability and non-stretchability.

In the embodiment shown, the textile sub-zones 40,42,44,46 of the first and second textile members 22,24 are arranged so that, when the stretchable textile article 220 is in an unstretched state, the non-stretchable first textile sub-zone 40 of the first textile member 22 overlaps with the non-stretchable second textile sub-zone 46 of the second textile member 24.

In a similar fashion to the embodiment of FIG. 1, applying a tensile load 48 to the joined first ends 26 and the joined second ends 28 results in relative stretch 50 between the first and second textile members 22,24 in opposite directions. This results in a reduction in overlap between the non-stretchable textile sub-zones 40,46 and therefore a reduction in distance between the stretchable textile sub-zones 42,44 as a result of the non-deformation, or minimal deformation, of the non-stretchable textile sub-zones 40,46, as shown in FIG. 11, In the event of the application of a sufficiently large tensile load 48, an overlap between the stretchable textile sub-zones 42,44 can be obtained.

FIG. 12 shows a side-by-side comparison of the unstretched and stretched states of the stretchable textile article 220.

After stretching the stretchable textile article 220 so that the overlap between the non-stretchable textile sub-zones 40,46 is reduced and so that the distance between the stretchable textile sub-zones 42,44 is reduced, a fastener 52 may be used to clip the non-stretchable textile sub-zones 40,46 together at the region of overlap, as shown in FIG. 13. Clipping the non-stretchable textile sub-zones 40,46 to each other prevents further stretch of the stretchable textile sub-zones 42,44 and therefore prevents further stretch of the stretchable textile article 220.

Optionally the fastener 52 may be also used to clip the non-stretchable textile sub-zones 40,46 together at the region of overlap when the stretchable textile article 220 is in an unstretched state, so as to prevent stretching of the stretchable textile article 220. as shown in FIG. 14.

It is envisaged that, in other embodiments of the invention, the stretchable textile article 220 of FIGS. 9a, 9b and 9c may include a plurality of first textile members instead of a single first textile member 22, and/or a plurality of second textile members instead of a single second textile member 24.

It is also envisaged that, in still other embodiments of the invention, the textile sub-zones 40,42,44,46 of the first and second textile members 22,24 are arranged so that, when the stretchable textile article 220 is in an unstretched state;

the stretchable first textile sub-zone 44 of the second textile member 24 overlaps with the stretchable second textile sub-zone 42 of the first textile member 22; or

the non-stretchable first textile sub-zone 40 of the first textile member 22 overlaps with the stretchable first textile sub-zone 44 of the second textile member 24 but does not overlap with the non-stretchable second textile sub-zone 46 of the second textile member 24, while the stretchable second textile sub-zone 42 of the first textile member 22 overlaps with the non-stretchable second textile sub-zone 46 of the second textile member 24 but does not overlap with the stretchable first textile sub-zone 44 of the second textile member 24.

Each of the embodiments 20,120,220 of FIG. 1, FIG. 5 and FIGS. 9a, 9b and 9c may be used as a structural support component for a garment.

In one example, the embodiment 20,120,220 of FIG. 1, FIG. 5 or FIGS. 9a, 9b and 9c is configured as a strap for a brassiere. After the brassiere is worn resulting in a stretched strap, the first and second textile members 22,24 can be fastened together to prevent further stretch of the strap, thus securing the brassiere in place. In another example, the embodiment 20,120,220 of FIG. 1, FIG. 5 or FIGS. 4a, 4b and 4c is configured as a waistband for a pair of trousers. After the pair of trousers is worn resulting in a stretched waistband, the first and second textile members 22,24 can be fastened together to prevent further stretch of the waistband, thus securing the pair of trousers in place. This obviates the need for a drawstring around the waistband.

Each of the embodiments 20,120,220 of FIG. 1, FIG. 5 and FIGS. 4a, 4b and 4c may be configured as a different type of structural support component, other than a strap or a band. Each of the embodiments 20,120,220 of FIGS. 1, FIG. 5 and FIGS. 4a, 4b and 4c may be used in another type of garment, a bag, a seat belt, footwear, or a technical textile,

It will be appreciated that, in embodiments of the invention, the textile zone of each textile member may be divided into any number of a plurality of textile sub-zones having different stretch properties.

It will also be appreciated that shading and/or hatching is used in the figures for clarity of illustration of the different features of the embodiments.

1. A stretchable textile article comprising a plurality of discrete textile members, each textile member extending between a first end and a second end, the first ends of the textile members being joined together, the second ends of the textile members being joined together, each textile member including a textile zone configured to have a variable stretch property in an orientation extending between the joined first ends and the joined second ends.

2. A stretchable textile article according to claim 1 wherein the textile members are arranged to:
extend parallelly, or substantially parallelly, between the joined first ends and the joined second ends; and/or
flank each other between the joined first ends and the joined second ends; and/or
overlie each other between the joined first ends and the joined second ends.

3. A stretchable textile article according to claim 1 wherein the textile zone of each textile member has a continuously or discontinuously variable stretch property in the orientation extending between the joined first ends and the joined second ends.

4. A stretchable textile article according to claim 1 wherein the textile zone of at least one of the textile members includes a plurality of textile sub-zones arranged successively in the orientation extending between the joined first ends and the joined second ends, each textile sub-zone has a respective constant or substantially constant stretch property, and the stretch properties of the textile sub-zones of the at least one textile member are different from each other.

5. A stretchable textile article according to claim 4 wherein the textile zone of each textile member includes first and second textile sub-zones arranged successively in the orientation extending between the joined first ends and the joined second ends, and the first and second textile sub-zones of each textile member are positioned towards the first and second ends respectively.

6. A stretchable textile article according to claim 1 wherein the plurality of textile members includes at least one first textile member and at least one second textile member, the stretch property of the textile zone of the or each first textile member increases away from the first end towards the second end, and the stretch property of the textile zone of the or each second textile member increases away from the second end towards the first end.

7. A stretchable textile article according to wherein the stretch properties of the first and second textile sub-zones of the or each first textile member are selected so that the first and second textile sub-zones of the or each first textile member respectively exhibit non-stretchability and stretchability, and the stretch properties of the first and second textile sub-zones of the or each second textile member are selected so that the first and second textile sub-zones of the or each second textile member respectively exhibit stretchability and non-stretchability.

8. A stretchable textile article according to claim 7 wherein the textile sub-zones of the first and second textile members are arranged so that, when the stretchable textile article is in an unstretched state:
the first textile sub-zone of the or each first textile member overlaps with the second textile sub-zone of the or each second textile member; or
the first textile sub-zone of the or each second textile member overlaps with the second textile sub-zone of the or each first textile member; or
the first textile sub-zone of the or each first textile member does not overlap with the second textile sub-zone of the or each second textile member, and the first textile sub-zone of the or each second textile member does not overlap with the second textile sub-zone of the or each first textile member.

9. A stretchable textile article according to claim 6 wherein the plurality of textile members includes a plurality of first textile members and/or a plurality of second textile members, wherein the first and second textile members are arranged to form alternately positioned first and second textile members.

10. A stretchable textile article according to claim 1 further including at least one fastener arranged to releasably fasten the textile members to each other at a fastening point or region between the first and second ends.

11. A stretchable textile article according to claim 10 wherein the or each fastener is configurable to releasably fasten the textile members to each other when the stretchable textile article is in an unstretched state and/or in at least one stretched state.

12. A stretchable textile article according to claim 1 wherein each textile member is in the shape of a strip.

13. A stretchable textile article according to claim 1 wherein the stretchable textile article is configured as a structural support component, or wherein the stretchable textile article is configured for forming part of a structural support component.

14. A stretchable textile article according to claim 13 wherein the structural support component is a strap or a band.

15. Use of a stretchable textile article according to claim 1 in a garment or a technical textile.
